(19) United States
(12) Patent Application Publication
(10) Pub. No.: US 2023/0099776 A1
(43) Pub. Date: Mar. 30, 2023

(54) METHOD AND APPARATUS FOR MONITORING LONG LENGTH TUBULAR STRUCTURES

(71) Applicant: Expro North Sea Limited, Dyce (GB)

(72) Inventors: John Henry McKay, Stonehaven (GB); David Sirda Shanks, Aberdeen (GB)

(21) Appl. No.: 17/956,328

(22) Filed: Sep. 29, 2022

(30) Foreign Application Priority Data
Sep. 29, 2021 (GB) 2113918.3

(51) Int. Cl. G01M 5/00; G01P 15/18

(52) U.S. Cl. CPC G01M 5/0025; G01M 5/0041; G01M 5/0066; G01P 15/18

(57) ABSTRACT

A system and method of monitoring a tubular structure is provided. The method includes: a) sensing one or more parameters relating to the tubular structure at spaced apart positions along the length of the tubular structure using a sensor module array having a plurality of sensor modules disposed in a cable attached to the tubular structure, the plurality of sensor modules producing communication signals representative of the sensed parameter at each position along the length of the tubular structure; and b) using a control unit to communicate with the sensor modules in the array, including receiving communication signals representative of the sensed parameter at each position along the length of the tubular structure, and processing the communications signals to produce information relating to the sensed parameter at the positions along the length of the tubular structure.

This application claims priority to GB Patent Appln. No. 2113918.3 filed Sep. 29, 2021, which is hereby incorporated by reference in its entirety.

### BACKGROUND OF THE INVENTION

### 1. Technical Field

The present disclosure relates to methods and apparatus for sensing one or more parameters on a tubular structure in general, and to methods and apparatus for sensing one or more parameters along a length of a long length tubular structure in particular.

### 2. Background Information

There are many engineered structures that employ long tubular elements that may be subjected to a harsh external environment during use. For example, subsea applications within the oil and gas industry utilize oil field subsea risers (e.g., for transport of fluids from a seabed to an above water platform) and umbilical production pipelines. Land-based applications include wind turbine towers, aerial masts, and the like that support equipment at substantial elevations. Very often, these long tubular structures are intended to have long service lives and are robustly designed to avoid failure.

There is a need, therefore, to have an ability to monitor the operational condition of these long tubular elements to ensure they structurally acceptable, and to monitor the effects if any the potentially harsh environment (which can be unpredictable) may have on these elements. Such monitoring can provide valuable actual information over the life of the structure that can be used to accurately determine present conditions of the structure and to allow in depth data-based useful life determination.

### SUMMARY

According to an aspect of the present disclosure, a system for monitoring a tubular structure having a length is provided. The system includes a sensor module array, a cable, and a control unit. The sensor module array has a plurality of sensor modules configured to sense one or more parameters relating to the tubular structure at spaced apart positions along the length of the tubular structure and produce communication signals representative of the sensed parameter at each position along the length of the tubular structure. The cable is configured to contain the sensor modules and configured to extend along the length of the tubular structure. The control unit is in communication with the sensor module array and a memory storing instructions. The instructions when executed cause the control unit to process the communication signals representative of the sensed parameter at each position along the length of the tubular structure and produce information relating to the sensed parameter at the positions along the length of the tubular structure.

In any of the aspects or embodiments described above and herein, at least one of the sensor modules may be configured to sense an amount of strain within the tubular structure at the respective position along the length of the tubular structure.

In any of the aspects or embodiments described above and herein, each sensor module within the sensor module array may be configured to sense the amount of strain within the tubular structure at the respective position along the length of the tubular structure.

In any of the aspects or embodiments described above and herein, at least one of the sensor modules may be configured to sense a position of the tubular structure at the respective position along the length of the tubular structure.

In any of the aspects or embodiments described above and herein, each sensor module within the sensor module array may be configured to sense a position of the tubular structure at the respective position along the length of the tubular structure.

In any of the aspects or embodiments described above and herein, each sensor module may be a 3-axis accelerometer and the instructions when executed may cause the control unit to process the communication signals representative of the sensed position of the tubular structure at each position along the length of the tubular structure.

In any of the aspects or embodiments described above and herein, the information relating to the sensed position of the tubular structure at the respective positions along the length of the tubular structure may include information relating to a bending of the tubular structure.

In any of the aspects or embodiments described above and herein, the information relating to the sensed position of the tubular structure at the respective positions along the length of the tubular structure may include information relating to a positional rotation of the tubular structure.

In any of the aspects or embodiments described above and herein, at least one of the sensor modules may be an acoustic sensor configured to sense spectral noise context external to the tubular structure.

In any of the aspects or embodiments described above and herein, the tubular structure may be a wind turbine tower supporting a wind turbine having a plurality of rotor blades, and the plurality of sensor modules may include at least one acoustic sensor disposed proximate the plurality of blades, and the acoustic sensor may be configured to sense spectral noise associated with rotation of the plurality of rotor blades.

In any of the aspects or embodiments described above and herein, at least one of the plurality of sensor modules may include a temperature sensor, a salinity sensor, a fluid velocity sensor, or a sensor configured to sense a coating or a surface condition of the tubular structure.

In any of the aspects or embodiments described above and herein, the tubular structure may be a wind turbine tower or a subsea riser.

According to an aspect of the present disclosure, a method of monitoring a tubular structure having a length is provided. The method includes: a) sensing one or more parameters relating to the tubular structure at spaced apart positions along the length of the tubular structure using a sensor module array having a plurality of sensor modules disposed in a cable attached to the tubular structure, the plurality of sensor modules producing communication signals representative of the sensed parameter at each position along the length of the tubular structure; and b) using a control unit to communicate with the sensor modules in the array, including receiving communication signals representative of the sensed parameter at each position along the length of the tubular structure, and processing the communications signals to produce information relating to the sensed parameter at the positions along the length of the tubular structure.

In any of the aspects or embodiments described above and herein, each sensor module within the sensor module array may be configured to sense the amount of strain within the tubular structure at the respective position along the length of the tubular structure and the information relating to the sensed parameter at the positions along the length of the tubular structure is representative of strain within the tubular structure along the length of the tubular structure.

In any of the aspects or embodiments described above and herein, each sensor module within the sensor module array may be configured to sense a position of the tubular structure at the respective position along the length of the tubular structure and the information relating to the sensed parameter at the positions along the length of the tubular structure is representative of a lengthwise bending or a twisting of the tubular structure relative to a predetermined position of the tubular structure.

In any of the aspects or embodiments described above and herein, each positional sensor module may be a 3-axis accelerometer.

In any of the aspects or embodiments described above and herein, the tubular structure may be a wind turbine tower supporting a wind turbine having a plurality of rotor blades, and the plurality of sensor modules may include at least one acoustic sensor disposed proximate the plurality of blades, and the step of sensing one or more parameters relating to the tubular structure may include sensing spectral noise associated with rotation of the plurality of rotor blades using the at least one acoustic sensor.

In any of the aspects or embodiments described above and herein, the information relating to the sensed parameter at the positions along the length of the tubular structure may be spectral noise associated with rotation of the plurality of rotor blades, and the method may further include processing the communication signals to determine the present of abnormal spectral noises associated with rotation of the plurality of rotor blades.

In any of the aspects or embodiments described above and herein, the tubular structure may be a wind turbine tower supporting a wind turbine having a plurality of rotor blades, and the plurality of sensor modules includes a plurality of fluid velocity sensors disposed at a plurality of spaced apart lengthwise positions of the wind turbine tower, and the step of sensing one or more parameters includes sensing a velocity and/or a turbulence of air in proximity to an external surface of the wind turbine tower at the plurality of spaced apart lengthwise positions of the wind turbine tower using the fluid velocity sensors.

In any of the aspects or embodiments described above and herein, the tubular structure may be a subsea riser, and the plurality of sensor modules may include a plurality of fluid velocity sensors disposed at a plurality of spaced apart lengthwise positions of the subsea riser, and the step of sensing one or more parameters may include sensing a velocity and/or a turbulence of seawater in proximity to an external surface of the subsea riser plurality of spaced apart lengthwise positions of the subsea riser using the fluid velocity sensors.

In any of the aspects or embodiments described above and herein, the plurality of sensor modules may include a plurality of vibration sensors disposed at a plurality of spaced apart lengthwise positions of the tubular structure, and the step of sensing one or more parameters may include sensing vibrations of the tubular structure using the vibration sensors.

In any of the aspects or embodiments described above and herein, the plurality of sensor modules includes at least one sensor module configured to sense a temperature of the tubular structure at the respective position along the length of the tubular structure.

In any of the aspects or embodiments described above and herein, the plurality of sensor modules may include a plurality of sensor modules each configured to sense a temperature of the tubular structure at a respective position along the length of the tubular structure.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

FIG. 1 is a diagrammatic representation of a marine hydrocarbon (e.g., oil and/or gas) producing well system.

FIG. 2 is a diagrammatic illustration of a marine hydrocarbon (e.g., oil and/or gas) producing well system with an embodiment of the present disclosure system, and a graph of sensed parameter values as a function of length of the tubular structure.

FIG. 3 is a diagrammatic illustration of a wind turbine system with an embodiment of the present disclosure system, and a graph of sensed parameter values as a function of length of the tubular structure.

FIG. 4 is a diagrammatic illustration of a present disclosure system embodiment, illustrating positional data of a tubular structure along three orthogonal axes (X, Y, and Z) produced by positional sensor modules attached to a length of the tubular structure.

FIG. 5 is a diagrammatic illustration of a present disclosure system embodiment, illustrating velocity data of a fluid flow external to a tubular structure along three orthogonal axes (X, Y, and Z) produced by sensor modules attached to a length of the tubular structure.

FIG. 6 is a diagrammatic illustration of a present disclosure system embodiment, illustrating waveform data relating to at least one parameter produced by sensor modules attached to a length of the tubular structure.

FIG. 7 is a graph of signal magnitude versus time showing a first transmitted signal (Tx), a second transmitted signal (Rx1), and a third transmitted signal at different data bit rates.

FIG. 8 is a graph of voltage versus frequency illustrating signal attenuation.

FIG. 9 is a graph of time versus bit rate.

FIG. 10 is a diagrammatic representation of a sensor module.

FIG. 11 is a diagrammatic representation of a control unit.

### DETAILED DESCRIPTION

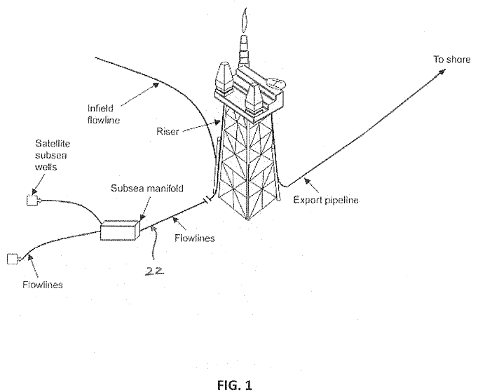

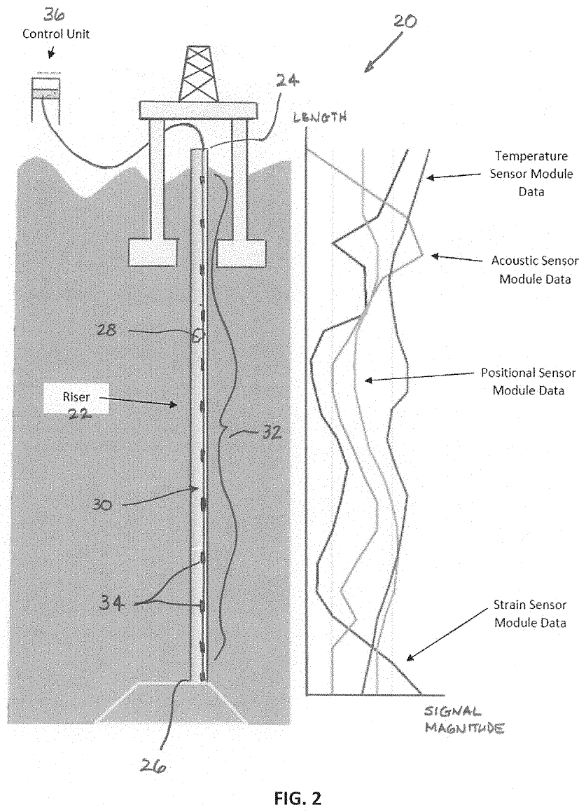

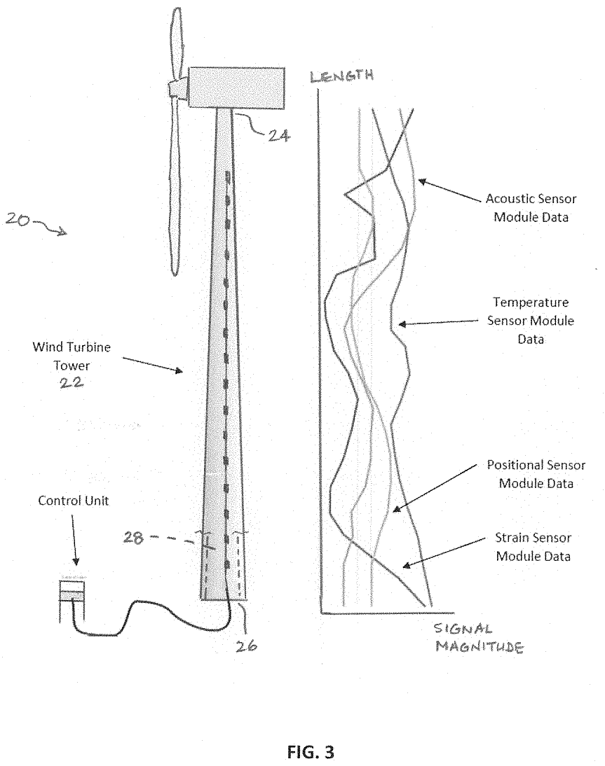

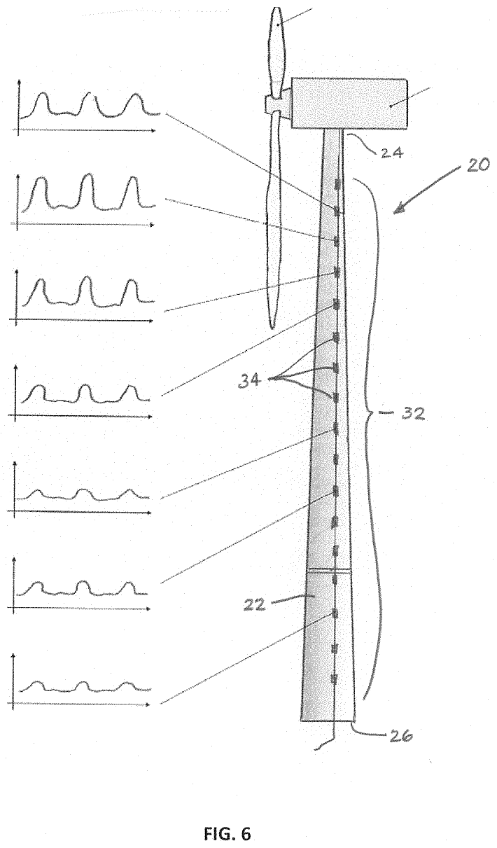

Referring to FIGS. 1 and 2, aspects of the present disclosure include a system 20 and method for monitoring a long length tubular structure 22 having a lengthwise extending axis. The length of the tubular structure 22 extends from a first lengthwise end 24 to a second lengthwise end 26. The present disclosure may be used with long tubular structures 22 such as subsea risers and subsea flow lines/production tubing extending between a subsea well head and a surface structure (e.g., rig or vessel), towers used to vertically support wind turbines, and the like. FIG. 1 illustrates an exemplary offshore drilling configuration including a riser, flowlines and pipelines. FIG. 2 diagrammatically illustrates an embodiment of the present disclosure system 20 in a subsea riser application. FIGS. 3 and 6 diagrammatically illustrate embodiments of the present disclosure system 20 in a wind turbine tower application. The present disclosure is not limited to these applications. The present disclosure provides particular benefit in these type applications, where the external environment can be hostile; e.g., seawater with strong currents, land-based applications subject to high winds, rain and snow, and the like. The axial length of these long tubular structures 22 can be significant; e.g., wind turbine towers can be well in excess of a hundred meters long, and subsea risers can have an axial length that is thousands of meters long. Typically, these long tubular structures 22 have a wall structure that defines an internal passage 28 that extends along the lengthwise axis. The tubular structures 22 often have a cylindrical cross-sectional configuration, but the present disclosure may be used regardless of the cross-sectional configuration of the tubular structure 22. Tubular structures 22 may comprise different materials and may have one or more coatings. The present disclosure is not limited to any particular tubular structure 22 configuration.

As will be described below in greater detail, embodiments of the present disclosure monitoring system 20 include a cable 30, an array 32 of sensor modules 34, and a control unit 36. The cable 30 extends lengthwise in the internal passage 28 of the tubular structure 22 or outside of the tubular structure 22.

The processing requirements of the system 20, including those of the control unit 36, sensor modules 34, and other elements of the system 20 may be accomplished in a variety of different ways. Any of the system 20 devices may include a processing unit having any type of computing device, computational circuit, processor(s), CPU, computer, or the like capable of executing a series of instructions that are stored in memory. The instructions may include an operating system, and/or executable software modules such as program files, system data, buffers, drivers, utilities, and the like. The executable instructions may apply to any functionality described herein to enable the system 20 to accomplish the same algorithmically and/or coordination of system components. A processing unit may include a single memory device or a plurality of memory devices. The present disclosure is not limited to using any particular type of non-transitory memory device, and may include read-only memory, random access memory, volatile memory, non-volatile memory, static memory, dynamic memory, flash memory, cache memory, and/or any device that stores digital information. A processing unit may include, or may be in communication with, an input device that enables a user to enter data and/or instructions, and may include, or be in communication with, an output device configured, for example to display information (e.g., a visual display or a printer), or to transfer data, etc. Communications between a processing unit and other system components may be via a hardwire connection or via a wireless connection.

The cable 30 may be attached to a surface of the tubular structure 22 internal passage 28 or may be attached to an exterior surface of the tubular structure 22. The cable 30 may be attached to the tubular structure 22 in a variety of different ways (e.g., using mechanical means such as clamps or the like) and is therefore not limited to any particular attachment means. The cable 30 includes a protective sheathing that is configured to contain and protect the sensor modules 34 and one or more communication lines in communication with the sensor modules 34 from the environment external to the cable 30. In some embodiments, the cable 30 may be a sealed structure that encloses sensor modules 34 and one or more communication lines. The cable 30 protects the aforesaid electronics from the environment outside of the cable 30 and facilitates attachment of the cable 30 to the tubular structure 22. For example, in a saltwater environment the cable 30 may be configured to protect the sensor modules 34 and communication lines from the saltwater, from the external environment temperature and/or pressure (e.g., excessively high or low), or the like, or any combination thereof. In land-based applications such as a wind turbine tower, the cable 30 may be configured to protect the sensor modules 34 and transmission lines from ultraviolet (UV) light degradation, corrosion, high and low temperatures, ice, or the like, or any combination thereof. As will be apparent from the disclosure below, one of the advantages of the present system 20 is that it avoids the need for multiple cables to support a large array of sensors to sense the length of a long tubular structure 22; e.g., by using an addressable low powered electronics system.

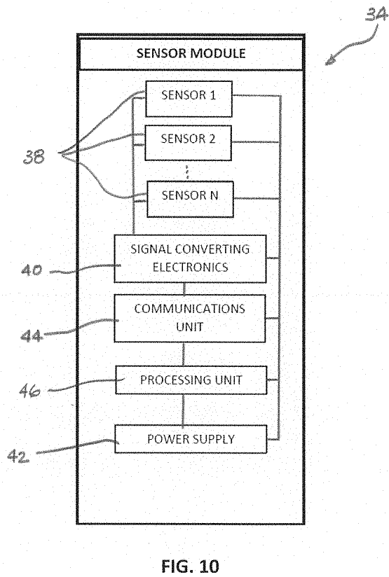

Referring to FIG. 10, each sensor module 34 within the sensor module array 32 includes at least one sensor 38 configured to produce sensor signal data. Except as otherwise provided herein, the sensor modules 34 are configured small enough to be disposed within the cable 30 and for very low power usage and are configurable to communicate with the control unit 36 over long cable 30 lengths. As will be described herein, the sensor modules 34 may employ high speed encoded communications to allow them to communicate over long cable 30 lengths; e.g., using frequency shift keying (FSK) or quadrature phase shift keying (QPSK) techniques.

In some embodiments, a sensor module 34 may also include electronics 40 for converting the sensor signal data into communication signals, a power supply 42 (e.g., AC or DC power) configured to provide electrical power to one or more sensors 38 (and/or other electronic components) within the sensor module 34, a communications unit 44 configured to send and/or receive communication signals (e.g., to and/or from the control unit 36, and in some embodiments other components within the system 20), and may include a processing unit 46 configured to execute stored instructions to perform the functions described herein. In some embodiments, the processing unit 46 may include a memory device operable to store signal data produced by one or more sensors 38. The term “communication signals” is used herein to refer to those signals sent between the control unit 36 and the respective sensor modules 34. In some embodiments, sensor signal data in the format produced by the respective sensor 38 may be a communication signal. Preferably, however, the communication signals are formatted (e.g., in data packets) to facilitate high speed communication over significant lengths. The communication signals may include sensor signal data and/or instructions and both the sensor modules 34 and the control unit 36 may be configured to receive and extract data from the communication signals, and to format data and instructions into the aforesaid format for transmission.

The sensor module array 32 includes a plurality of sensor modules 34 (e.g., up to one hundred (100) or more in some applications), and the sensor modules 34 include at least one type of sensor. For example, the sensor module array 32 may include a plurality of different types of sensors 38; e.g., “N” number of first type sensors, “M” number of second type sensors, “P” number of third type sensors, etc., where “N”, “M”, and “P” are integers equal to or greater than one. The sensor modules 34 are in communication with one or more communication lines that extend from the respective sensor module 34 to a position (referred to hereafter as a “base position”) where the communication lines can be coupled with the control unit 36 and/or with other devices for communication of signals to and/or from the sensor modules 34.

The sensors 38 within the sensor module array 32 are configured to sense one or more parameters relating to the tubular structure 22. Examples of sensor 38 types that may be included within the sensor module array 32 include strain sensors, temperature sensors, acoustic sensors, vibration sensors, positional sensors, and the like.

In a sensor module array 32 embodiment that includes strain sensors 38, the strain sensors may be disposed spaced apart from one another along the length of the cable 30 to provide information regarding the amount of strain the tubular structure 22 is subjected to at respective lengthwise positions of the structure. In some embodiments, a plurality of strain sensors can be circumferentially spaced apart from one another at a lengthwise position of the tubular structure 22. Circumferentially spaced apart strain sensors disposed at a lengthwise position can provide greater information regarding strain within the tubular structure 22. In some embodiments, the sensor module array 32 may be configured so that the strain sensors are attached or bonded to the tubular structure 22; i.e., to a surface of the internal passage 28 or to an exterior surface. In some embodiments, one or more strain sensors may be external to the cable 30. In some of these embodiments, the strain sensor may be configured to wirelessly communicate signals (e.g., electromagnetic signals) representative of the sensed strain to a portion of the strain sensor (or other receiver) that is internal to the cable 30. In this manner, there is no aperture in the cable 30 sheathing that may permit leakage into the cable 30 interior passage and the external strain sensor portions can be readily attached, bonded, or integrated into the tubular structure 22. The present disclosure is not limited to any particular type of strain sensor; e.g., a strain sensor that may be driven entirely using high frequency AC power is an example of an acceptable strain sensor. Positioning a plurality of strain sensors at lengthwise positions along the tubular structure 22 (e.g., every “X” inches) may be particularly useful to produce data that is representative of strain within the tubular structure 22 at rest as well as strain associated with particular events encountered by the tubular structure 22; e.g., forces acting on the structure as a result of strong seawater currents, winds, objects striking the structure, and the like. The system 20 may be configured such that the strain sensors provide information representative of absolute strain values and/or produce information representative of changes in strain within the tubular structure 22. FIG. 2 diagrammatically illustrates an embodiment of the present system 20 in a subsea riser application and a graph illustrating the magnitude of strain present within the subsea riser at lengthwise positions. FIG. 3 diagrammatically illustrates an embodiment of the present system 20 in a wind turbine tower application and a graph illustrating the magnitude of strain present within the wind turbine tower at lengthwise positions.

The sensor module array 32 may include one or more temperature sensors 38. In those embodiments having a plurality of temperature sensors, individual temperature sensors may be disposed along the length of the cable 30, spaced apart from one another. Signal data from temperature sensors disposed along the length of a tubular structure 22, for example, may be used to provide information regarding temperature gradients within the fluid surrounding the tubular structure 22, which in turn can provide information regarding fluid zones surrounding the tubular structure 22. FIG. 2 diagrammatically illustrates an embodiment of the present system 20 in a subsea riser application and a graph illustrating temperature data along the subsea riser at lengthwise positions. FIG. 3 diagrammatically illustrates an embodiment of the present system 20 in a wind turbine tower application and a graph illustrating temperature data along the wind turbine tower at lengthwise positions.

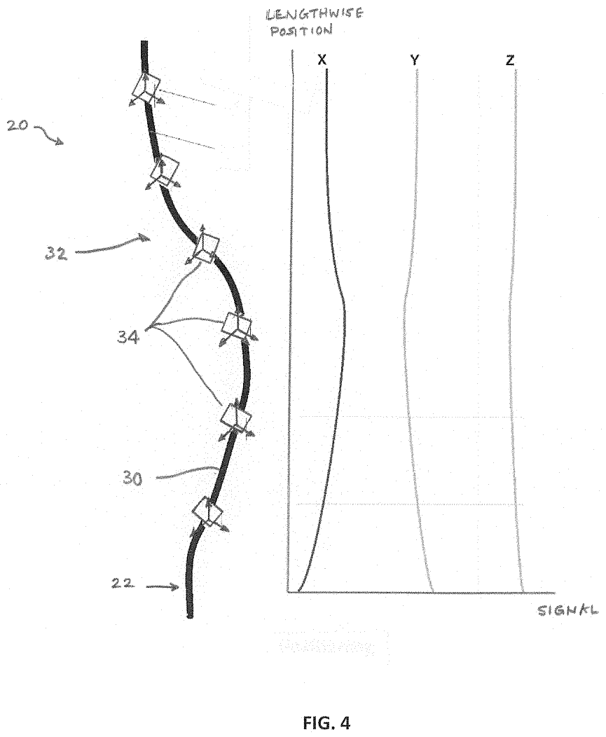

The sensor module array 32 may include one or more positional sensors 38. In some embodiments, one or more positional sensors may be disposed at a distal end of the tubular structure 22; e.g., proximate the turbine end of a wind turbine tower. In some embodiments, a plurality of positional sensors may be disposed along the length of a tubular structure 22. A non-limiting example of an acceptable positional sensor is a three-axis accelerometer. In some embodiments, a three-axis accelerometer having a frequency response of about 1 KHz and that produces a DC signal output may be particularly useful. Signal data from the positional sensors may be used to establish an “at rest” position (and/or an originally disposed position) where the tubular structure 22 resides in the absence of external forces acting on the tubular structure 22. The aforesaid signal data can also be used to determine positional deviations from the at rest position; e.g., the direction of positional deviation (bending), positional rotation (twisting), the magnitude of positional deviation, the frequency of positional deviation, etc. The aforesaid direction and magnitude of bending itself can be quite useful in assessing the operability of the tubular structure 22. In some embodiments, the system 20 may be configured to produce one or more maps illustrating current and/or historic position of the tubular structure 22; e.g., inclination, bending, and/or rotation or twist of the structure along multiple axes (e.g., 3-D). In addition, three-dimensional positional deviation information can be used for determining/confirming/updating the remaining useful life of the tubular structure 22. Still further, the signal data from the positional sensors may be used to in combination with the strain sensors in determinations of strain present within the tubular structure 22. Alternatively, the positional sensor 38 data (e.g., from DC sensing of the 3-axis accelerometers) measuring the absolute position of the tubular structure 22 (including positional deviations from the at rest position, such as bending, direction of bending, twisting, the magnitude and/or frequency of these positional deviations, etc.) may be used to determine strain directly or indirectly within the tubular structure 22. Hence, the signal data from the positional sensors may be used to determine the actual overall shape of the tubular structure 22 (bending, location, and inclination) and the mechanical status of the structure. FIG. 2 diagrammatically illustrates an embodiment of the present system 20 in a subsea riser application and a graph illustrating data representative of the incline (i.e., positional data) of the subsea riser at lengthwise positions. FIG. 3 diagrammatically illustrates an embodiment of the present system 20 in a wind turbine tower application and a graph illustrating data representative of the incline (i.e., positional data) of the wind turbine tower at lengthwise positions. FIG. 4 diagrammatically illustrates an embodiment of the present system 20 in a subsea riser application and a graph illustrating positional data in multiple directions (e.g., orthogonal axes X, Y, and Z) collected by the sensor module array 32 along the subsea riser at lengthwise positions. FIG. 6 diagrammatically illustrates a present disclosure embodiment having a sensor module array 32 and cable 30 attached lengthwise to a wind turbine tower. The sensor modules 34 in FIG. 6 may include positional sensors (e.g., 3-axis accelerometers) configured to sense position relative to vertical/gravity. The signals from these positional sensors may be processed into waveform for analysis as will be described herein.

The sensor module array 32 may include one or more acoustic sensors 38 configured to sense spectral noise content originating from outside of the tubular structure 22 (e.g., propagating within the seawater or air outside of the structure) and/or to sense spectral noise content originating within the internal passage 28 of the tubular structure 22. To sense the environment external to the tubular structure 22, the acoustic sensors may be oriented with sensing surfaces pointed outwardly. To sense the interior of the tubular structure 22, the acoustic sensors may be oriented with sensing surfaces pointed inwardly. The characteristics of the acoustic sensors (e.g., sensitivity, directional characteristics, frequency bandwidth, dynamic range, size, and the like) can be chosen based on the application. In some embodiments, output of the acoustic sensors may be processed with noise cancelling technology; e.g., to remove “steady state” noise from the acoustic sensor output. In some embodiments, the acoustic sensors 38 may have a single frequency band width sensor sufficiently broad to capture all acoustic signals of interest. In these embodiments, the signal output from the sensors may be selectively filtered (e.g., using band pass filters) to capture certain distinct portions of the sensed frequency band. Alternatively, in some embodiments a plurality of different acoustic sensors 38 (e.g., acoustic sensors having different acoustic characteristics such as different band widths) can be utilized to capture spectral noise from distinct different acoustic sources; e.g., different frequency bands, etc. The acoustic sensors may be disposed lengthwise positions along a tubular structure 22 to provide information regarding fluid flow, tubular structure contact, and the like at different lengthwise positions along the tubular structure 22. In some embodiments, a plurality of acoustic sensors (e.g., having different directional characteristics) can be circumferentially spaced apart from one another at a lengthwise axial position of the tubular structure 22. Such an acoustic sensor arrangement may be used to provide 3D information regarding fluid turbulence and structural vibrations. In some embodiments, acoustic sensors can be disposed at predetermined positions to provide information relating to adjacent elements. For example, in a wind turbine application it may be useful to provide one or more acoustic sensors at one or more positions to detect acoustic signals produced by the airfoil blades traversing past or adjacent the acoustic sensors. The degree of acoustic signal uniformity produced by the airfoil blades may be used as an indicator that all of the airfoil blades are operating in a uniform manner. For example, periodic acoustic signals that are substantially different may be an indicator that one airfoil blade is operating differently from the other blades; e.g., at least one of the airfoil blades is structurally different from the other airfoil blades, for example as a result of a bird strike, erosion, failure, ice buildup, etc., or the pitch of at least one of the blades is different from the other airfoil blades, or at least one of the airfoil blades has a different vibrational response (e.g., different resonant frequency) than the other airfoil blades, etc. Acoustic signals produced by the airfoil blades may also be used to determine airfoil blade speed, turbulence produced by the airfoil blades, etc. In some embodiments, the signal data from acoustic sensors may be utilized to identify fluid characteristics adjacent the tubular structure 22 within an acceptable range (e.g., wind speeds below a predetermined value) and to identify fluid characteristics above an acceptable range (e.g., wind speeds above a predetermined value). In some embodiments, the signal data produced by the acoustic sensors may be collected periodically and a “normal” acoustic signature identified. If the sensed acoustic signals depart from this normal acoustic signature, the system 20 may be configured to alert an operator. FIG. 2 diagrammatically illustrates an embodiment of the present system 20 in a subsea riser application and a graph illustrating data representative of fluid flow acoustic signals along the subsea riser at lengthwise positions. FIG. 3 diagrammatically illustrates an embodiment of the present system 20 in a wind turbine tower application and a graph illustrating data representative of fluid flow acoustic signals along the wind turbine tower at lengthwise positions. FIG. 6 diagrammatically illustrates a present disclosure embodiment having a sensor module array 32 and cable 30 attached lengthwise to a wind turbine tower. The sensor modules 34 in FIG. 6 may include acoustic sensors configured to sense spectral noise. The signals from these acoustic sensors may be processed into waveform for analysis as will be described herein.

The sensor module array 32 may include one or more vibration sensors 38 configured to measure vibrations of the tubular structure 22. The characteristics of the vibration sensors (e.g., sensitivity, frequency bandwidth, dynamic range, and the like) can be chosen based on the application. In some embodiments, a plurality of different vibration sensors (e.g., vibration sensors having different sensing characteristics such as frequency bandwidth) can be utilized to produce signal data representative of different vibrational excitations. The vibration sensors may be disposed along the length of a tubular structure 22 to provide information regarding differences in vibrations at different axial length positions along the tubular structure 22. In some embodiments, the signal data representative of vibrational excitations may be processed to establish those associated with “normal conditions” for the application at hand. Collected vibrational signal data may be compared against normal conditions vibrational data to identify any potential issue. As described below, signal data representative of vibrational excitations may be produced in waveform. The shape and or frequencies of vibrational signal waveforms may be used to identify waveform patterns (e.g., waveforms of known mechanical failure modes) that differ from “normal” waveform patterns. FIG. 6 diagrammatically illustrates a present disclosure embodiment having a sensor module array 32 and cable 30 attached lengthwise to a wind turbine tower. The sensor modules 34 in FIG. 6 may include vibration sensors configured to sense vibration of the tower. The signals from these vibration sensors may be processed into waveform for analysis as will be described herein.

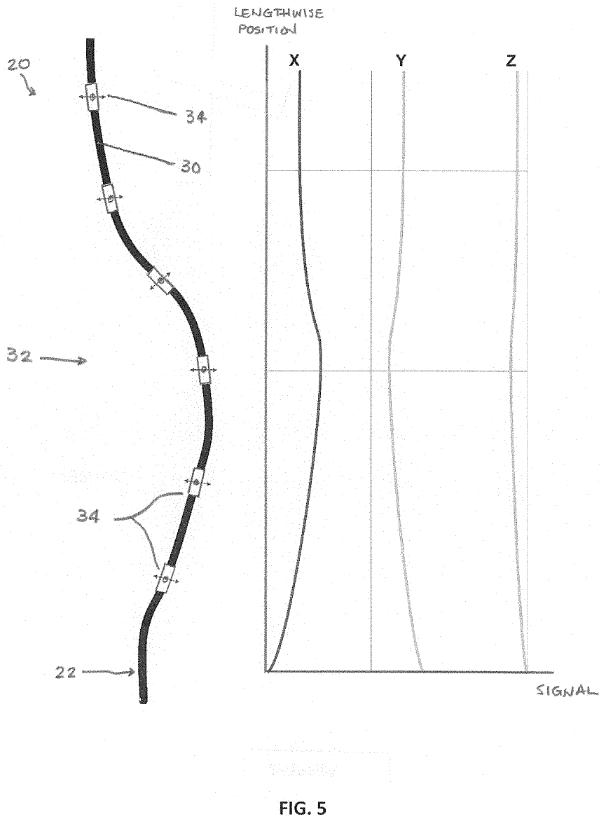

The sensor module array 32 may include one or more fluid velocity sensors 38 configured to measure fluid velocity relative to the tubular structure 22. An anemometer (e.g., a “button” or “hot-wire” type anemometer) is an example of a fluid velocity sensor. These devices include a member (e.g., a button, wire, pins, etc.) that is electrically heated to a temperature above ambient. Air flowing past the heated member cools the member. As the electrical resistance of the member is dependent upon the temperature of the member, the velocity of the fluid passing the member can be determined based on the electrical resistance of the member. Such an anemometer can be configured to have an extremely high frequency-response and therefore may be used to provide information regarding an amount of turbulence within the fluid flow. Hence, some present disclosure sensor module arrays 32 may utilize one or more anemometers proximate the airfoil blades of a windmill application to provide information regarding air flow velocity and/or turbulence. FIG. 5 diagrammatically illustrates an embodiment of the present system 20 in a subsea riser application and a graph illustrating fluid flow velocity data in multiple directions (e.g., orthogonal axes X, Y, and Z) collected by the sensor module array 32 along the subsea riser at lengthwise positions.

The sensor module array 32 may include one or more salinity sensors 38 configured to measure the salinity of seawater proximate a subsea riser (or other subsea tubular structure 22). The salinity sensors may be disposed along the length of the subsea riser to provide information regarding differences in salinity at different axial length positions along the subsea riser. In some applications, the salinity sensors may also provide information regarding seawater flows by detecting variations in salinity at different axial length positions of the subsea riser (e.g., depths).

The sensor module array 32 may include one or more sensors 38 configured to provide information relating to one or more coatings and/or surface conditions on the tubular structure 22; e.g., information regarding surface corrosion, organic growth (e.g., mold, barnacles, etc.). The aforesaid information relating to one or more coatings and/or surface conditions on the tubular structure 22 may be produced based on an initial determined value and potential deviations from that initial value. An ultrasonic transducer is a non-limiting example of a sensor that may be used to provide information relating to tubular structure 22 wall thickness and/or relating to one or more coatings and/or surface conditions on the tubular structure 22. An ultrasonic transducer can be configured to produce ultrasonic signals (i.e., acting as a transmitter) that will propagate through the wall of the tubular structure 22. Some portion of the ultrasonic signals reaching an interface between two different materials (e.g., an interface between the tubular structure 22 wall and the fluid disposed outside the wall, or between the tubular structure 22 wall and a coating adhered to the wall, etc.) will reflect backward toward the source of the ultrasonic signals. The reflected signals may be sensed by an ultrasonic signal configured as a receiver, or the same ultrasonic transducer that emitted the signal may act as both a transmitter and a receiver. The reflected signals may be analyzed to produce information regarding the thickness of the material through which the signal has propagated. In similar fashion, if the tubular structure 22 has a coating adhered to its surface, transmitted and received ultrasonic signals can be used to produce information regarding the thickness of the materials (i.e., the tubular structure 22 wall and the coating) through which the signal has propagated. In similar fashion, if a foreign material (e.g., corrosion, organic materials, etc.) has attached to the exterior surface of the tubular structure 22 (or to a coating attached to the wall), the aforesaid ultrasonic transducer system may be used to provide information regarding the presence of such a material, the thickness of the material, and possibly the type of material. U.S. Pat. No. 8,117,918 “Method and Apparatus for Determining Pipewall Thickness Using One or More Ultrasonics Sensors”, which is hereby incorporated by reference, describes an example of a system and method that may be adapted for use with the present disclosure. An example of an ultrasonic transducer that would be useful in such an application is a low frequency ultrasonic transducer; e.g., one operating at a frequency associated with a wavelength that is equal to or greater than about one-third of the wall thickness. For thinner walls or for providing information regarding thinner “substrates” such as coatings or corrosion, a higher frequency transducer may be used. The present disclosure is not limited to any particular ultrasonic sensor system for providing information relating to one or more coatings and/or surface conditions on the tubular structure 22 and is not limited to using ultrasonic transducers to provide information relating to one or more coatings and/or surface conditions on the tubular structure 22.

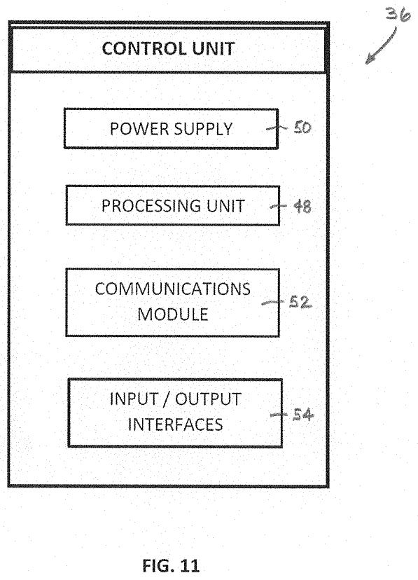

Referring to FIG. 11, the control unit 36 includes a processing unit 48 and a power supply 50 (or is in communication with a power supply) and is configured to communicate with the sensor module array 32. The control unit 36 is in communication with sensor module array 32. In some embodiments, the control unit 36 processing unit 48 may be configured to directly send communication signals and receive communication signals from the sensor modules 34 within the sensor module array 32. In these embodiments, the control unit 36 processing unit may be configured to extract signal data produced by the sensors 38 for analysis. In other embodiments, the control unit 36 may include a communications module 52 that is configured to format communication signals outgoing to the sensor modules 34 and to extract sensor signal data produced by the sensors 38 from incoming communication signals sent by sensor modules 34 for subsequent storage and/or analysis. In some embodiments, the control unit 36 may include one or more interfaces 54 configured for communication with external devices such as input devices (e.g., operator input devices) and output devices (e.g., displays, external storage, remote access, etc.).

As stated above, a sensor module 34 may include a communications unit 44 (“SM communications unit”) and the control unit 36 may include a communications module 54 (“CU communications module”) both of which are configured to format communication signals into a format (e.g., a data packet) that can be received and accessed by the other of the sensor module 34 or control unit 36 to enable communications therebetween. The present disclosure is not limited to any particular communication technique between the sensor modules 34 and the control unit 36. In some embodiments, the system 20 may employ high speed encoded communication techniques that facilitate signal communication over long cable 30 lengths. Frequency shift keying (FSK) and quadrature phase shift keying (QPSK) are examples of techniques that may be used.

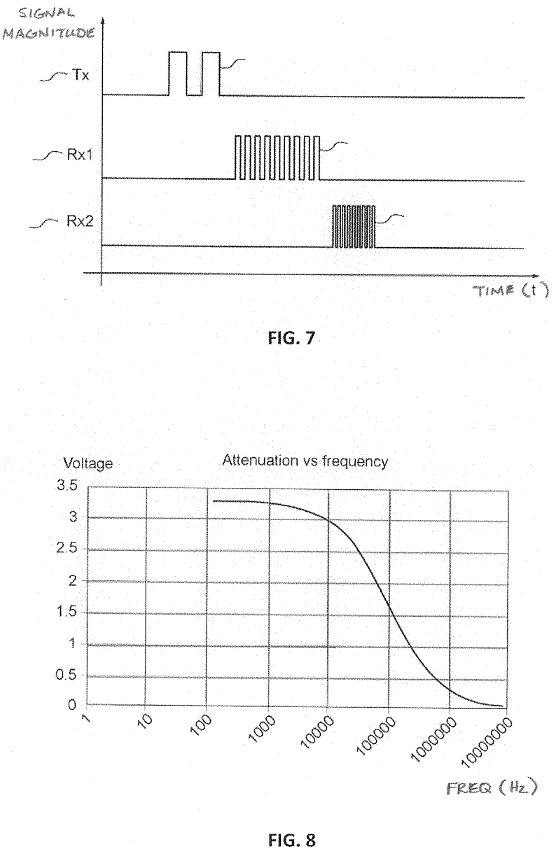

In some embodiments of the present disclosure, the system 20 may be configured such that the SM communications units and the CU communications module utilize variable signal bit rates to transmit communication signals. A non-limiting example of how variable signal bit rates may be used to transmit communication signals is diagrammatically shown in FIGS. 7-9. In FIG. 7, control signals (Tx) transmitted at a control signal bit rate by the control unit 36 is diagrammatically shown, first communication signals transmitted in response at a first data bit rate by a first sensor module (Rx1) is shown, and a second communication signals transmitted in response at a second data bit rate by a second sensor module (Rx2) is shown. The first data bit rate is greater than the control signal bit rate, and the second data bit rate is greater than the first data bit rate. It can be seen from the example shown in FIG. 7 that the signals representing the first communication signals and the second communication signals comprise the same number of cycles, and therefore the same total quantity of data, but the second communications data signals require less time to be received than the time required to receive the first sensor data signals due to the difference in bit rate between the two.

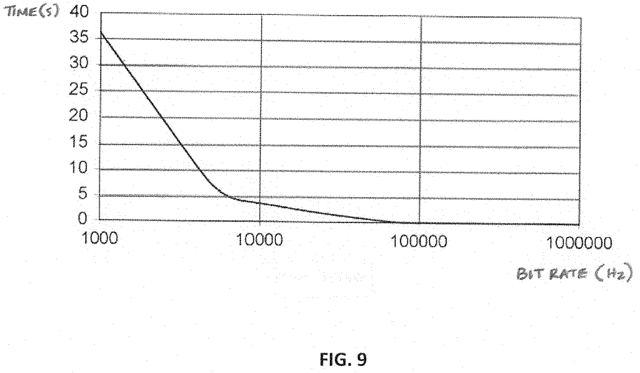

There is, however, a tradeoff between bit rate and signal attenuation. On the one hand, the graph of voltage (attenuation) versus frequency provided in FIG. 8 illustrates that attenuation increases with bit rate (frequency). Hence, although a higher bit rate decreases the time required to receive the signal, it also increases the attenuation of the signal. In fact, FIG. 8 shows that there is a practical maximum bit rate because signal attenuation eventually degrades the signal to the point where the signal is indiscernible. On the other hand, FIG. 9 illustrates a graph of time (seconds) versus bit rate (Hz). Hence, it can be seen from FIG. 9 that a higher bit rate is preferred as it allows more measurement data from the sensor data signals to be gathered in a given time, but as shown in FIG. 8 the higher the bit rate the greater the amount of signal attenuation. Embodiments of the present disclosure address the tension between bit rate and attenuation by having the data signal bit rate of each sensor module 34 be chosen based on the distance that sensor module 34 is spaced apart on the cable 30 from the control unit 36. Hence, the system 20 may be configured so that each sensor module 34 utilizes a bit rate that optimizes the amount of time required to receive the signal while maintaining an acceptable degree of attenuation. For example, where there are two sensor modules (Rx1, Rx2) mounted on the cable 30, and where the first sensor module (Rx1) is located a first distance along the cable 30 from the control unit 36 and the second sensor module (Rx2) is located a second distance along the cable 30 from the control unit 36, the second distance being less than the first distance, the first data sensor bit rate at which the first sensor module (Rx1) transmits communication signals to the control unit 36 via the cable 30 is less than the second sensor data bit rate at which the second sensor module (Rx2) transmits communication signals to the control unit 36 via the cable 30 (i.e., the first sensor data bit rate<the second sensor data bit rate). The difference between the first sensor data bit rate and the second sensor data bit rate may be chosen based on the difference between the first distance and the second distance. In an embodiment, the difference between the first sensor data bit rate and the second sensor data bit rate may be chosen to be proportional to the difference between the first distance and the second distance. To illustrate further, where there are N>2 sensor modules 34 installed on the cable 30, the data sensor bit rate at which each sensor module 34 is configured to transmit are chosen based on the distance along the cable 30 between the control unit 36 and the respective sensor module 34. In this way, each sensor module 34 located successively further from the control unit 36 can be configured to transmit at a lower bit rate than the preceding, closer sensor module 34. This configuration can maximize the total amount of data that the control unit 36 receives from the plurality of sensor modules 34 in a given time period for a given capability of the system 20 to resolve attenuated communication signals.

In some embodiments the control unit 36 may be configured to optimize bit rates. For example, the control unit 36 may be configured to analyze the level of attenuation present in the communication signals (e.g., data packets) as a function of the bit rates at which they were sent as well as relative to a maximum bit rate that the system 20 can support a sensor module 34 transmitting. The control unit 36 may store and analyze this data over a given period of time. Based on that analysis, the control unit 36 may then communicate to a sensor module 34 a maximum bit rate to be used (which may differ from a previous maximum bit rate). In this way the control unit 36 may configure a respective sensor module 34 to subsequently transmit at that maximum bit rate. The control unit 36 may repeat this process to initially configure sensor modules 34 and/or to update sensor modules 34 until all of the sensor modules 34 have been configured with respective maximum bit rates. In an embodiment, the maximum bit rates vary between about 10 kHz to about 100 kHz.

Embodiments of the present disclosure can provide advantages over currently known sensing techniques. For example, some currently known sensing techniques involve operating sensors at a relatively low periodic rate or frequency to produce sensor signal data points that may be considered “static”. This data is then often processed by averaging, smoothing, or filtering it, or the like, to remove noise. Signal processing of this sort typically involves discarding some amount of the collected sensor signal data as unusable or of limited value.

In some embodiments of the present disclosure, in contrast, the system 20 may be configured to operate sensor modules 34 at higher sampling rates, for example in a spectrum typically in the tens (10's) of kHz. The sensor signal data may then be processed into waveform to capture most if not all of the collected sensor signal data as a function of time. The waveform capture is preferably done with a vertical resolution (e.g., signal magnitude) that is sufficiently high to permit measurement of smaller magnitude signal components. In this manner, the present disclosure is able to utilize more of the sensor signal data collected, which in turn enhances the ability of the present disclosure to sense high frequency parameters as will be described below. Many physical parameter sensors like pressure sensors, temperature sensors, fluid flow sensors, and the like, have mechanical limitations on the maximum frequency to which they can respond. The present disclosure waveform processing provides a means for overcoming these inherent limitations and makes available high frequency parameter information that would otherwise be unavailable in relation to measuring parameters along a long length tubular structure 22. There are many uses of waveform type data that are valuable and which also cannot be obtained from static measurements. Typically, these relate to fast moving fluids such as is found in any subsea structure, or a wind turbine tower, and also relates to noise and vibration created with physical contact between objects in the vicinity of the tubular structure 22 like adjacent risers or towers, and also natural impacts from debris, fishing nets, and creatures. This use of high frequency information allows the basic static sensor information to be extended to also contain considerable additional information including but not limited to: mechanical vibrations, fluid vortices and fluid flow-based eddies and noise, audible noise and audible noise patterns, shock waves and pressure fronts travelling over the sensor, noise created by solids entrained in the flowing fluid, noise created by failure of tubing joints, bolted flanges, or other mechanical fixings, noise created by the blades of a windmill passing the mast on every rotation, the frequency indicating blade speed, and turbulence in the air around the blade, and noise created by the blades of a subsea turbine blade as it rotates in the ocean current.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures—such as alternative materials, structures, configurations, methods, devices, and components, alternatives as to form, fit, and function, and so on—may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein. For example, in the exemplary embodiments described above within the Detailed Description portion of the present specification, elements are described as individual units and shown as independent of one another to facilitate the description. In alternative embodiments, such elements may be configured as combined elements.

Additionally, even though some features, concepts, or aspects of the disclosures may be described herein as being a preferred arrangement or method, such description is not intended to suggest that such feature is required or necessary unless expressly so stated. Still further, exemplary or representative values and ranges may be included to assist in understanding the present application, however, such values and ranges are not to be construed in a limiting sense and are intended to be critical values or ranges only if so expressly stated.

Moreover, while various aspects, features and concepts may be expressly identified herein as being inventive or forming part of a disclosure, such identification is not intended to be exclusive, but rather there may be inventive aspects, concepts, and features that are fully described herein without being expressly identified as such or as part of a specific disclosure, the disclosures instead being set forth in the appended claims. Descriptions of exemplary methods or processes are not limited to inclusion of all steps as being required in all cases, nor is the order that the steps are presented to be construed as required or necessary unless expressly so stated. The words used in the claims have their full ordinary meanings and are not limited in any way by the description of the embodiments in the specification.

1. A system for monitoring a tubular structure having a length, comprising:
a sensor module array having a plurality of sensor modules configured to sense one or more parameters relating to the tubular structure at spaced apart positions along the length of the tubular structure and produce communication signals representative of the sensed parameter at each position along the length of the tubular structure;
a cable configured to contain the sensor modules and configured to extend along the length of the tubular structure; and
a control unit in communication with the sensor module array and a memory storing instructions, which instructions when executed cause the control unit to process the communication signals representative of the sensed parameter at each position along the length of the tubular structure and produce information relating to the sensed parameter at the positions along the length of the tubular structure.

2. The system of claim 1, wherein at least one of the sensor modules is configured to sense an amount of strain within the tubular structure at the respective position along the length of the tubular structure.

3. The system of claim 1, wherein at least one of the sensor modules is configured to sense a position of the tubular structure at the respective position along the length of the tubular structure.

4. The system of claim 3, wherein each positional sensor module is a 3-axis accelerometer and the instructions when executed cause the control unit to process the communication signals representative of the sensed position of the tubular structure at each position along the length of the tubular structure.

5. The system of claim 3, wherein the information relating to the sensed position of the tubular structure at the respective positions along the length of the tubular structure includes information relating to a bending of the tubular structure.

6. The system of claim 3, wherein the information relating to the sensed position of the tubular structure at the respective positions along the length of the tubular structure includes information relating to a twist of the tubular structure.

7. The system of claim 1, wherein at least one of the sensor modules is an acoustic sensor configured to sense spectral noise context external to the tubular structure.

8. The system of claim 7, wherein the tubular structure is a wind turbine tower supporting a wind turbine having a plurality of rotor blades, and the plurality of sensor modules includes at least one acoustic sensor disposed proximate the plurality of blades, and the acoustic sensor is configured to sense spectral noise associated with rotation of the plurality of rotor blades.

9. The system of claim 1, wherein at least one of the plurality of sensor modules includes a temperature sensor, a salinity sensor, a fluid velocity sensor, or a sensor configured to sense a coating or a surface condition of the tubular structure.

10. The system of claim 1 wherein the tubular structure is a wind turbine tower or a subsea riser.

11. A method of monitoring a tubular structure having a length, comprising:
sensing one or more parameters relating to the tubular structure at spaced apart positions along the length of the tubular structure using a sensor module array having a plurality of sensor modules disposed in a cable attached to the tubular structure, the plurality of sensor modules producing communication signals representative of the sensed parameter at each position along the length of the tubular structure;
using a control unit to communicate with the sensor modules in the array, including receiving communication signals representative of the sensed parameter at each position along the length of the tubular structure, and processing the communications signals to produce information relating to the sensed parameter at the positions along the length of the tubular structure.

12. The method of claim 11, wherein each sensor module within the sensor module array is configured to sense the amount of strain within the tubular structure at the respective position along the length of the tubular structure and the information relating to the sensed parameter at the positions along the length of the tubular structure is representative of strain within the tubular structure along the length of the tubular structure.

13. The method of claim 11, wherein at least one of the sensor modules is a configured to sense a position of the tubular structure at the respective position along the length of the tubular structure.

14. The method of claim 13, wherein each sensor module within the sensor module array is configured to sense a position of the tubular structure at the respective position along the length of the tubular structure and the information relating to the sensed parameter at the positions along the length of the tubular structure is representative of a lengthwise bending or a twisting of the tubular structure relative to a predetermined position of the tubular structure.

15. The method of claim 13, wherein each positional sensor module is a 3-axis accelerometer.

16. The method of claim 11, wherein at least one of the sensor modules is an acoustic sensor configured to sense spectral noise context external to the tubular structure.

17. The method of claim 11, wherein the tubular structure is a wind turbine tower supporting a wind turbine having a plurality of rotor blades, and the plurality of sensor modules includes at least one acoustic sensor disposed proximate the plurality of blades, and the step of sensing one or more parameters relating to the tubular structure includes sensing spectral noise associated with rotation of the plurality of rotor blades using the at least one acoustic sensor.

18. The method of claim 17, wherein the information relating to the sensed parameter at the positions along the length of the tubular structure is the spectral noise associated with rotation of the plurality of rotor blades, and further comprising processing the communication signals to determine the present of abnormal spectral noises associated with rotation of the plurality of rotor blades.

19. The method of claim 11, wherein the tubular structure is a wind turbine tower supporting a wind turbine having a plurality of rotor blades, and the plurality of sensor modules includes a plurality of fluid velocity sensors disposed at a plurality of spaced apart lengthwise positions of the wind turbine tower, and the step of sensing one or more parameters includes sensing a velocity and/or a turbulence of air in proximity to an external surface of the wind turbine tower at the plurality of spaced apart lengthwise positions of the wind turbine tower using the fluid velocity sensors.

20. The method of claim 11, wherein the tubular structure is a subsea riser, and the plurality of sensor modules includes a plurality of fluid velocity sensors disposed at a plurality of spaced apart lengthwise positions of the subsea riser, and the step of sensing one or more parameters includes sensing a velocity and/or a turbulence of seawater in proximity to an external surface of the subsea riser plurality of spaced apart lengthwise positions of the subsea riser using the fluid velocity sensors.

21. The method of claim 11, wherein the plurality of sensor modules includes a plurality of vibration sensors disposed at a plurality of spaced apart lengthwise positions of the tubular structure, and the step of sensing one or more parameters includes sensing vibrations of the tubular structure using the vibration sensors.

22. The method of claim 11, wherein the plurality of sensor modules includes at least one sensor module configured to sense a temperature of the tubular structure at the respective position along the length of the tubular structure.

23. The method of claim 11, wherein the plurality of sensor modules includes a plurality of sensor modules each configured to sense a temperature of the tubular structure at a respective position along the length of the tubular structure.
